(19) United States
(12) Patent Application Publication
(10) Pub. No.: US 2013/0132187 A1
(43) Pub. Date: May 23, 2013

(54) REWARD PROGRAM SYSTEM AND METHODS OF USING SAME

(71) Applicant: Robert J. Burmaster, Minneapolis, MN (US)

(72) Inventor: Robert J. Burmaster, Minneapolis, MN (US)

(21) Appl. No.: 13/475,234

(22) Filed: May 18, 2012

Related U.S. Application Data
(60) Provisional application No. 61/487,540, filed on May 18, 2011.

(51) Int. Cl. G06Q 30/02

(52) U.S. Cl. CPC G06Q 30/0233
USPC 705/14.33

(57) ABSTRACT

A reward program system is disclosed that comprises a server hosting a database of rewards, a user interface connected to the server, and an algorithm configured to present a reward purchase opportunity to a participant upon the participant's completion of a behavior objective, and the algorithm is configured to allow a participant to purchase one or more rewards from the database wherein the participant pays at least a first portion of the reward price and a sponsor pays at least a second portion of the price. The algorithm may be configured to allow the participant to select at least two rewards from the database prior to the completion of the objective and the algorithm may establish an expiration time by which the participant may purchase or forfeit the rewards from the database.

### CROSS-REFERENCE TO RELATED APPLICATION

This application claims priority to U.S. Provisional Patent Application No. 61/487,540, filed May 18, 2011, which is hereby incorporated herein in its entirety.

### BACKGROUND

Incentive, recognition and learning programs that help businesses drive behavior and achieve results from salespeople, channel partners, employees and customers are generally known. Examples include programs that reward sales people for achieving sales goals, programs that recognize employees for providing outstanding service, and programs that reward customers for using particular credit card services. In many systems, rewards are typically given to program participants in the form of reward points that accrue in a reward program bank account. Participants can then redeem their points on their choice of an item in a rewards catalog. Each item in the rewards catalog has a price in points. The participant must save up enough points to get the item of his or her choice. Once a participant redeems points for an item, the proper points are deducted from the reward account, and the item is fulfilled to the participant.

### BRIEF SUMMARY

One embodiment of the present system is a reward program comprising a server configured to host a computer accessible database of rewards, a user interface electronically connected to the server, and a computer program algorithm configured to operate the user interface and access the database of rewards and to present a reward purchase opportunity to a reward program participant to purchase at least one of at least two rewards upon the participant's completion of a behavior objective. The algorithm may be further configured to allow the reward program participant to select a set of at least two rewards from the database prior to the completion of the behavior objective, and the algorithm may be configured to establish an expiration time by which the reward program participant may purchase or forfeit one or more rewards from the database. In addition, the algorithm may be further configured to allow a reward program sponsor to manage sponsor system parameters.

Another embodiment of the reward program system comprises a server configured to host a computer accessible database of rewards wherein each reward has a reward price, a user interface electronically connected to the server, and a computer program algorithm configured to operate the user interface and access the database of rewards and to allow a reward program participant to purchase one or more rewards from the database, wherein the reward program participant pays at least a first portion of the reward price and a reward program sponsor pays at least a second portion of the reward price.

Further variations and combinations of features of this reward program system are explained in greater detail below.

### DESCRIPTION OF THE DRAWINGS

FIG. 1 is a schematic of a computer network configured to operate a reward program system.

FIG. 2 is a schematic of a reward deal promotion process in the reward program system.

FIG. 3 is a schematic of a reward deal pricing and billing process in the reward program system.

### DETAILED DESCRIPTION

The reward program system has two principal processes. The first process is a reward deal promotion process. The second process is a reward deal pricing and billing process. Several elements are common to both processes.

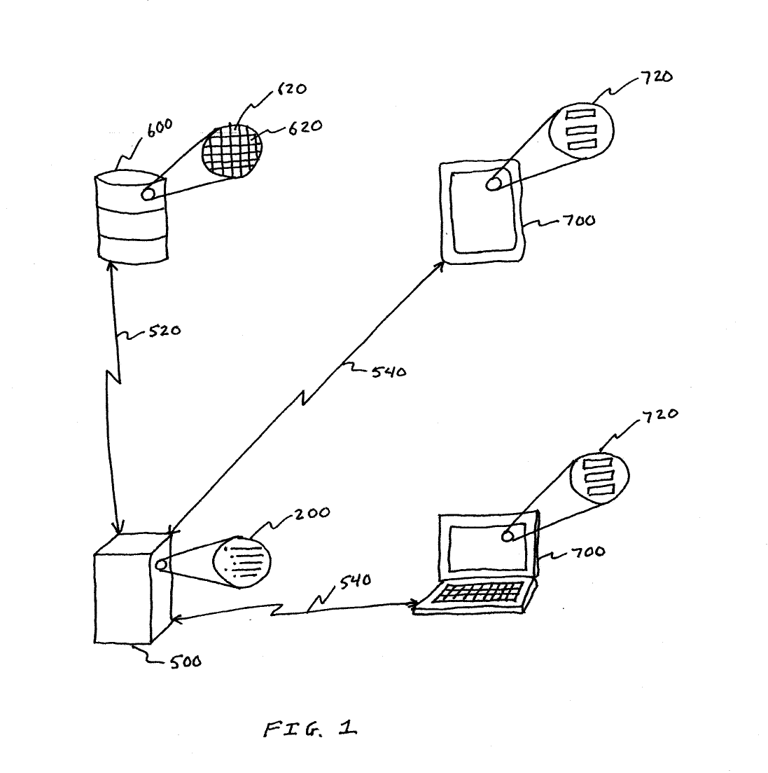

As shown in FIG. 1, both processes comprise a computer software program or algorithm 200 configured to run on a central computer processing unit or a server 500. The server 500 may host or be in electronic communication through a wired or wireless network connection 520 with a database 600 that includes a plurality of rewards or reward deals 620. The algorithm 200 is configured to allow a computer programmer or program manager to create and modify the database 600 as well as its architecture and content. In some embodiments, the system may comprise multiple databases.

The server 500 is also in electronic communication through a wired or wireless network connection 540 with one or more computing devices 700 configured to host or run a user interface 720. The computing devices 700 may be of any number or type configured to operate a user interface 720, which may be a portion of, connected to, or in communication with the algorithm 200. Such devices 700 may include but are not limited to cellular telephones, personal digital assistants, and computers of all types, including tablet computers, laptops, and desktops. The user interface 720 may comprise a dedicated software application run locally on the device 700 or an Internet website or other software program accessible through the Internet or other dedicated computer network accessible on the device 700. The algorithm 200 is configured to allow a computer programmer or program manager to create and modify the architecture and content of all user interfaces 720.

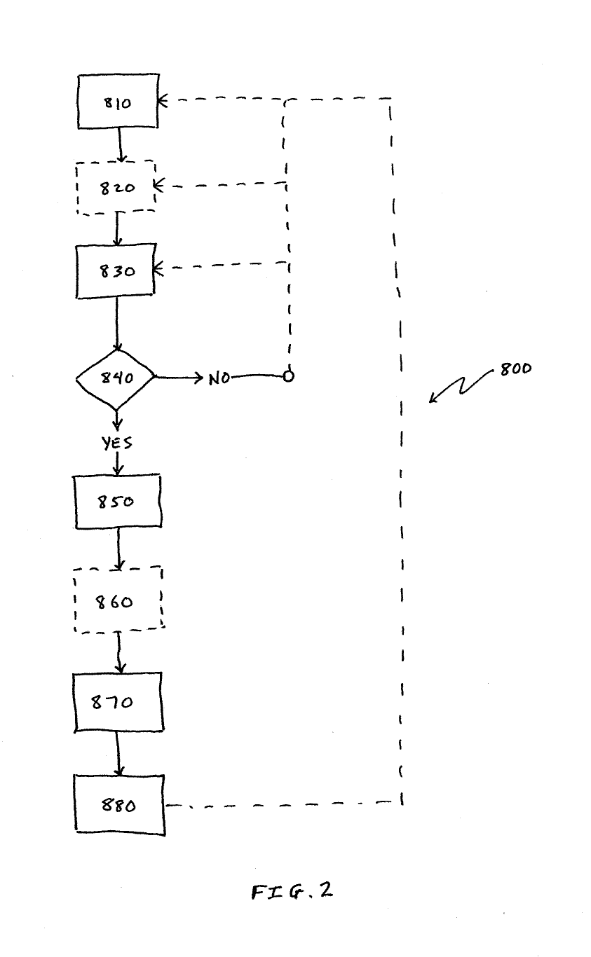

In some embodiments, the algorithm 200 is configured to operate a reward deal promotion process 800 as shown in FIG. 2. The purpose of the process 800 is to incentivize the completion of a behavior objective for one or more reward program participants. The first step 810 in the process 800 is to set one or more behavior objectives for one or more reward program participants. Both the behavior objectives and the participants may be uniquely identified and tracked by the algorithm 200 in the database 600. By way of examples and not limitation, behavior objectives may include achieving a sales goal, achieving a service goal, receiving an award, completing a task, or using a particular product or service. Optional second step 820 is for the reward program participant to select a set of at least two reward deals 620 from the database 600 towards which the participant can work towards “unlocking” to be made available by achieving a behavior objective. The participant completes this step by using a user interface 720 configured to allow the user to select one or more deal sets presented to him or her through the algorithm 200. The third step 830 is for the participant to work towards the behavior objective set for him or her. Next, step 840 assesses whether the participant has met his or her behavior objective. If the answer is no, the participant may return to the first step 810, second step 820, or third step 830, depending upon the particular embodiment. In some embodiments, the participant may be dismissed from the reward program system entirely. The algorithm 200 may be configured to update the database 600 in order to keep a record of each participant's status with respect to his or her then-pending behavior objectives.

If at step 840 the participant has achieved his or her behavior objective, then the participant proceeds to step 850 in which the algorithm 200 unlocks or makes available a set of one or more reward deals 620 from the database 600 to the participant. In embodiments that include optional step 820 in which the participant has selected the set of deals prior to achieving the objective, these deals are unlocked or made available in step 850 to the participant through the user interface 720. In some embodiments that include optional step 820, it may be desirable in step 850 for the algorithm 200 to unlock an additional or “bonus” reward deal 620 from the database 600 not previously selected by the participant.

In some embodiments, optional step 860 may be included in the algorithm 200 in which one or more time limits may be applied to the reward deals 620 unlocked in step 850. Step 860 may be implemented in a variety of ways in various embodiments, including but not limited to: (a) having all unlocked reward deals 620 expire at the same time; (b) having each reward deal 620 expire at a different time; (c) having the quality of one or more of the reward deals 620 diminish with time in any number of various increments, be they seconds, minutes, hours, days, or other units of time. Other variations may be used in step 860. In embodiments using optional step 860, the algorithm 200 may be configured to track any time limits applicable to particular reward deals 620, reward deal sets, and participants in the database 600.

In step 870, the reward program participant selects and purchases one of the reward deals 620 unlocked in step 850 through a user interface 720. In some embodiments, the participant may purchase the reward deal 620, and in such embodiments, the algorithm 200 is configured to accept payment from the participant. In some embodiments, one or more reward deals may be deliverable to the participant without monetary payment, or may be purchased through the exchange of some form of banked benefits, points, credit, or monetary substitute. The algorithm 200 records in the database 600 that the particular reward deal and set of deals to the particular participant has been purchased so that the participant cannot obtain reward deals to which he or she is not entitled under the algorithm 200. Step 870 and subsequent steps may be omitted by participants who choose not to purchase any of the unlocked reward deals 620.

In step 880, the reward deal 620 purchased by the participant in step 870 is fulfilled to the participant. In some embodiments, the reward deal may comprise physical goods or gift cards or certificates that must be delivered to the participant, in which case any one of a number of conventional delivery methods may be employed. In some embodiments, some reward deals 620 may comprise codes or other non-physical items that can be fulfilled through electronic or other communication means to the participant. As in step 870, in step 880 or a subsequent step, the algorithm 200 is configured to record in the database 600 that the particular reward deal 620 has been fulfilled to the particular participant. In some embodiments, the database 600 may be configured to monitor inventory of particular reward deals 620 as well as any other data associated with particular deals and participants. In some embodiments, after completing step 880 a participant may optionally return to step 810.

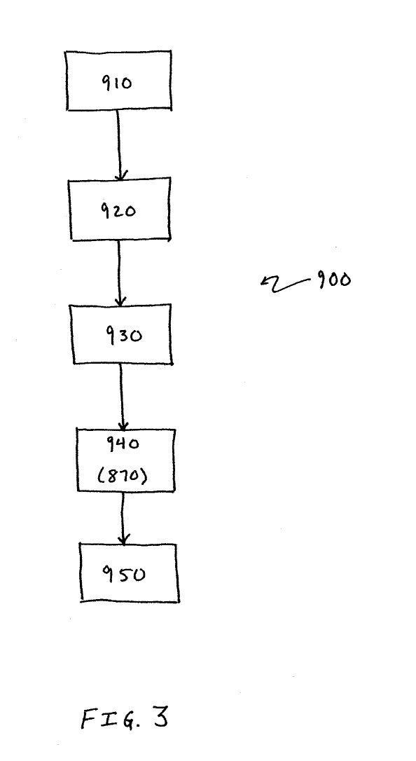

In some embodiments, the algorithm 200 is configured to operate a reward deal pricing and billing process 900 as shown in FIG. 3. The first step 910 of the pricing and billing process is for a program manager or operator to establish sets of reward deals 620 from the database 600 of all available reward deals. Reward deal sets may comprise any number of reward deals 620 and may comprise as few as one reward deal 620. In one exemplary embodiment, a reward deal set comprises two reward deals 620. In another exemplary embodiment, a reward deal set comprises three reward deals 620. In yet another exemplary embodiment, a reward deal set comprises four reward deals 620. These exemplary embodiments are not intended to be limiting. Reward deal sets having more than four reward deals 620 may be used. The reward deal sets may be designed and selected based upon a variety of criteria, including but not limited to cost, reward program participant information, and reward program sponsor information. A reward program sponsor may be, for example, a business entity or employer that seeks to use the reward program system to incentivize employee productivity. In another example, a reward program sponsor may be a credit card company that seeks to use the reward program system to incentivize the use of credit cards that it issues.

In step 920, the program manager or operator establishes a total sell price for each reward 620 in the reward deal set based upon the cost of the reward and the operator's desired profit. In step 930, the program manager or operator designates a portion of the total sell price for each reward 620 in the reward deal set as the participant price, and the remainder of the total sell price is designated as the program sponsor price. The program sponsor price may be further divided among more than one sponsor. In some embodiments, it may be desirable to set the participant price for one reward in a reward deal set at zero. Further, in some embodiments, it may be desirable to apportion the participant price and the sponsor price for some reward deals so that both prices are less than the cost of the reward.

In step 940, the reward program participant pays the participant price for one of the reward deals in the deal set. This step corresponds to step 870 in the reward deal promotion process 800. Finally, in step 950 the algorithm 200 generates an invoice to the program sponsor for the program sponsor price of the particular reward deal purchased by the program participant.

The following table provides an example of a reward deal set comprising three rewards and their associated costs and prices in an exemplary embodiment wherein the reward program sponsor is willing to provide up to a seventy-five dollar incentive for the participants that it sponsors to achieve the relevant behavior objectives:

| | | Total Sell | | | Participant | Sponsor Savings |
|---|---|---|---|---|---|---|
| | | Price | | | Savings % | vs. Face Value |
| Reward | Reward | (Cost + | Participant | Sponsor | vs. Reward | of Highest Value |
| 620 | Cost | Profit) | Price | Price | Face Value | Reward ($75) |
| $50 Retailer | $50 | $62 | $20 | $42 | 60% | $33 |
| Gift Card | | | | | | |
| $25 Credit | $25 | $35 | $0 | $35 | 100% | $40 |
| Gift Card | | | | | | |
| $75 Gas | $75 | $100 | $40 | $60 | 42% | $15 |
| Gift Card | | | | | | |

In the foregoing table, the reward program sponsor achieves a savings for each reward in the reward deal set compared to the face value of the seventy-five dollar incentive. In addition, the participant has a plurality of choices for maximizing the value proposition most important to him or her, whether it be the type of reward, the absolute dollar savings offered by the reward, or the percentage of savings of the participant price versus the face value of the reward.

In some embodiments of the reward program system, the algorithm 200 and one or more user interfaces 720 may be configured to allow a reward program sponsor to manage the steps of the reward deal promotion process 800 for use by the participants that it sponsors. In some embodiments of the reward program system, the algorithm 200 and one or more user interfaces 720 may be configured to allow a reward program sponsor to manage one or more steps of the reward deal pricing and billing process 900, in particular, the first step 910 of that process of creating reward deal sets for use by the participants that it sponsors.

One exemplary embodiment of the reward program system comprises a server configured to host a computer accessible database of rewards, a user interface electronically connected to the server, and a computer program algorithm configured to run the user interface and access the database of rewards, wherein the algorithm is configured to present a reward purchase opportunity to a reward program participant to purchase at least one of at least two rewards upon the participant's completion of a behavior objective. This embodiment may further comprise the algorithm being configured to allow the reward program participant to select a set of at least two rewards from the database prior to the completion of the behavior objective. This embodiment may also comprise the algorithm being configured to establish an expiration time by which the reward program participant may purchase or forfeit one or more rewards from the database, and in this embodiment, the algorithm may be further configured to allow a reward program sponsor to manage sponsor system parameters.

Another exemplary embodiment of the reward program system comprises a server configured to host a computer accessible database of rewards wherein each reward has a reward price, a user interface electronically connected to the server, and a computer program algorithm configured to run the user interface and access the database of rewards wherein the algorithm is configured to allow a reward program participant to purchase one or more rewards from the database wherein the reward program participant pays at least a first portion of the reward price and a reward program sponsor pays at least a second portion of the reward price. In this embodiment, the algorithm may be configured to allow the reward program participant to select a set of at least two rewards from the database prior to the completion of a behavior objective, and the algorithm may also be configured to establish an expiration time by which the reward program participant may purchase or forfeit one or more rewards from the database. Further, the algorithm may be configured to allow the reward program sponsor to manage sponsor system parameters.

Yet another exemplary embodiment of the reward program system, comprises a server configured to host a computer accessible database of rewards wherein each reward has a reward price, a user interface electronically connected to the server, and a computer program algorithm configured to run the user interface and access the database of rewards wherein the algorithm is configured to present a reward purchase opportunity to a reward program participant upon the participant's completion of a behavior objective and the algorithm is further configured to allow a reward program participant to purchase one or more rewards from the database wherein the reward program participant pays at least a first portion of the reward price and a reward program sponsor pays at least a second portion of the reward price. In this embodiment, the algorithm may be configured to allow the reward program participant to select a set of at least two rewards from the database prior to the completion of the behavior objective and the algorithm may be configured to establish an expiration time by which the reward program participant may purchase or forfeit one or more rewards from the database. In addition, the algorithm may be configured to allow the reward program sponsor to manage sponsor system parameters.

While the reward program system has been described in reference to some exemplary embodiments, these embodiments are not limiting and are not necessarily exclusive of each other, and it is contemplated that particular features of various embodiments may be omitted or combined for use with features of other embodiments while remaining within the scope of the invention.

What is claimed is:

1. A computer-implemented method of operating a reward program, comprising the steps of:
(a) providing one or more rewards wherein each reward has a reward price; and
(b) selling the one or more rewards to a reward program participant via an online user interface, wherein the reward program participant pays a first portion of the reward price, and a reward program customer pays a second portion of the reward price.

2. The method of claim 1, wherein the one or more rewards are made available for sale to the reward program participant only after the reward program participant has met a pre-defined goal.

3. The method of claim 2, the pre-defined goal including achieving a sales goal, achieving a service goal, receiving an award, completing a task, and using a particular product.

4. The method of claim 3, the one or more rewards being displayed to the reward program participant via the online user interface before the reward program participant has met or failed to meet the pre-defined goal.

5. The method of claim 4, further comprising providing a bonus reward if the reward program participant completes a pre-defined bonus goal, wherein the bonus reward is not displayed to the reward program participant via the online user interface until the pre-defined bonus goal is met.

6. The method of claim 5, further comprising providing a time limit by which the reward program participant must meet the pre-defined bonus goal and if the pre-defined bonus goal is not met within the time period, the bonus reward cannot be won by the reward program participant.

7. The method of claim 3, further comprising providing a time limit by which the reward program participant must meet the pre-defined goal and if the pre-defined goal is not met within the time period, the one or more rewards are no longer made available to the reward program participant.

8. The method of claim 7, wherein the time period expires at the same time for each of the one or more rewards.

9. The method of claim 7, wherein the time period expires at a different time for each of the one or more rewards.

10. The method of claim 7, wherein the one or more rewards becomes less valuable as the time period gets closer to expiring.

11. A computer-implemented method of operating a reward program, comprising the steps of:
(a) providing one or more rewards wherein each reward has a reward price, and the one or more rewards and the reward price is displayed to a reward program participant via an online user interface;
(b) presenting a reward purchase opportunity to the reward program participant upon the participant's attainment of a goal; and
(c) selling a reward to the reward program participant wherein the reward program participant pays a first portion of the reward price and a reward program customer pays a second portion of the reward price.

12. The method of claim 11, wherein the reward price is paid in dollars.

13. The method of claim 11, further comprising providing a point bank, wherein the participant can earn points that are tracked in a database.

14. The method of claim 13, wherein the points are earned based on the participant's progress toward attaining the goal.

15. The method of claim 14, wherein the portion of the reward price paid by the participant is paid in points.

16. A computer-implemented method of operating a reward program, comprising the steps of:
(a) providing one or more rewards wherein each reward has a reward price;
(b) presenting a reward purchase opportunity to a reward program participant to purchase at least one of at least two rewards upon the participant's attainment of a goal; and
(c) selling a reward to the reward program participant via an online user interface wherein the reward program participant pays a first portion of the reward price and a reward program customer pays a second portion of the reward price.

17. The method of claim 16, the one or more rewards being displayed to the reward program participant via the online user interface before the reward program participant has met or failed to meet the pre-defined goal.

18. The method of claim 16, further comprising providing a bonus reward if the reward program participant completes a pre-defined bonus goal, wherein the bonus reward is not displayed to the reward program participant via the online user interface until the pre-defined bonus goal is met.

19. The method of claim 18, further comprising providing a time limit by which the reward program participant must meet the pre-defined bonus goal and if the pre-defined bonus goal is not met within the time period, the bonus reward cannot be won by the reward program participant.

20. The method of claim 17, further comprising providing a time limit by which the reward program participant must meet the pre-defined goal and if the pre-defined goal is not met within the time period, the one or more rewards are no longer made available to the reward program participant.
